(19) United States
(12) Patent Application Publication
(10) Pub. No.: US 2013/0262260 A1
(43) Pub. Date: Oct. 3, 2013

(54) METHOD AND APPARATUS FOR PRODUCING AND MARKETING TAILORED ON-DEMAND DISPOSABLE GARMENTS AND UNDERGARMENTS FOR HYGIENE PRODUCTS

(71) Applicant: TAMICARE LTD., Manchester (GB)

(72) Inventors: Tamar Giloh, Manchester (GB); Ehud Giloh, Manchester (GB); Reuven Melamed, Zikhron Ya'akov (IL)

(21) Appl. No.: 13/852,254

(22) Filed: Mar. 28, 2013

Related U.S. Application Data
(60) Provisional application No. 61/617,788, filed on Mar. 30, 2012.

(51) Int. Cl. G06Q 30/06

(52) U.S. Cl. CPC G06Q 30/0621; G06Q 30/0603
USPC 705/26.5; 700/132

(57) ABSTRACT

A method and apparatus for producing custom made disposable garments and undergarments for hygiene products are disclosed. The method includes customization of the disposable garment for a consumer. The customization may include use of a consumer's measurements, 3D body scanning data, style, color, design, and decoration preferences, for example. The apparatus includes a manufacturing line having a main program driven manufacturing control processor to convert and apply prerecorded consumer information into production orders to be used on a versatile production line, and to enable a dedicated production process for an individual consumer, as well as a versatile production line specified to produce tailored on demand disposable nonwoven garments and undergarments using the consumer's prerecorded information.

### CROSS REFERENCE TO RELATED APPLICATIONS

The present application claims priority to U.S. Provisional Application No. 61/617,788 filed Mar. 30, 2012, which is hereby incorporated by reference in its entirety.

### BACKGROUND

Disposable garments and undergarments products are used every day by consumers of every age. As long as life duration prolongs, more people will be using disposable incontinence products for extended periods, which makes the use of these products a significant part of peoples' lives nearly as much as clothing. However, these consumers have to adapt existing product/s, out of a given range of styles and sizes. Consumers have no choice but to use products that don't fit them properly or nicely, and that consumers do not feel good about the products they use every day, or during some days per month. The packaging of these products, in most cases a nylon bag containing several products, also does not impart a dignified feel. As consumers may need to use products during a significant time of their lives, the desire for a better, personal choice is something to look at.

### SUMMARY

Today's technology allows manufacturers to produce disposable products tailored to specific demands of customers in various parameters, but still use a mass production line with almost no increase in manufacturing costs. Custom made products have a great appeal to the customer and can have a strong influence on his/her buying habits, thus increasing the manufacturer's control over customer's satisfaction, while offering personalized, high desired and feel good solutions, and maintaining a direct marketing channel to the consumer. Such products cover all ages: babies, toddlers, kids, teenagers, young and elderly adults. Products for specific jobs and for pets could also be supplied using this unique channel. E-commerce allows for the personal and direct contact in an easy and discreet way.

A versatile and adaptable production line is also provided to enable the production of custom made products on a mass production line. The line integrates usual line elements and unique quick part and material altering mechanisms that allow a constant and fluent production of individual or small batches of products. The products or small batches are different from one another in product properties according to customer's predefined product design.

The products may be packaged in stylish shipping boxes. Such boxes may look like a drawer with dividers creating smaller “cells” for each individual product or per model.

### BRIEF DESCRIPTION OF THE FIGURES

FIG. 1 shows an example apparatus for use with the present application; and

FIG. 2 shows an example packaging box for use with the present application.

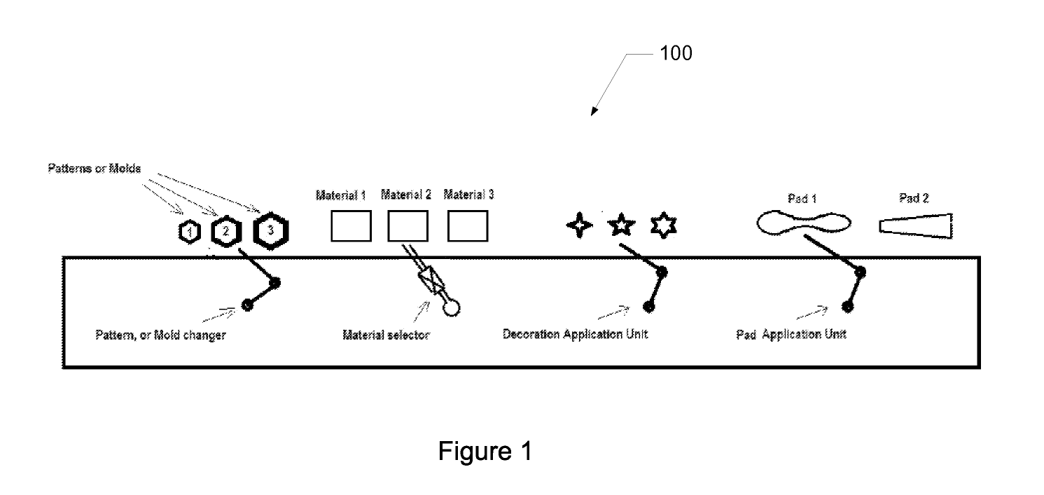

### DETAILED DESCRIPTION

In one embodiment, the method comprises a measurement of the consumer's specific personal body 3D size and shape, the measurement process may be performed by the consumer using means supplied to the consumer. The measurement means may be, for example, any 3D scanner or 3D visual simulation, based on a series of photos. The photos or scanning data may be provided by any digital media equipment such as but not limited to, personal computer, tablet, digital camera, cell phone and the like. The measurement data may be dispatched to the manufacturer via electronic media such as, but not limited to, email, by registering on a dedicated personal page on a dedicated internet site, or by using a dedicated cellular application. The measurement or scanning data is used to produce a product that conforms accurately to the consumer's personal body size, shape, and fit, as described in U.S. Pat. No. 7,700,030 which is fully incorporated by reference herein, as well as personal design and style preference.

In another embodiment, the personal measurements may be used to create a personal dedicated production template such as, but not limited to, a mold.

In another embodiment, the personal measurements may be compared to a pre-existing database or library of similar measurements. The personal measurements or scanned data may be compared to find the same or a similar match, within a defined tolerance. The same or similar match may be used for production optimization in order to reduce the number of individual templates, yet provide the consumer a precise, custom fit product.

In another embodiment the consumer selects the product's design and style from a library or a catalog of different styles and designs to be sent to the consumer as a collection. The manufacturer integrates the consumer's body measurements data or scanning data received from the consumer with the chosen products' models and styles to create the custom made products.

In another embodiment, the catalog is an on-line catalog which is directly connected to planning pre-determined software (such as an ERP system) and which converts the consumer on-line choices into the manufacturing plan.

In another embodiment, a product is produced with areas in which additional decoration may be applied by the consumer, the product is then packaged and sold as a kit including additional decoration elements that may be applied on the product, or with tools for creating personal decorations (for example color pencils or other painting colors suitable for decorating the product) by the consumer. The decoration may also include customized elements such as the consumer's name, initials, logo, monogram, photos, etc.

In yet another embodiment the consumer may select scents to be added to any specific product.

In yet another embodiment the consumer may select the type/size of the absorptive device to be attached to the disposable product, if required.

The disposable garments may include, for example, an incontinence undergarment, a feminine hygiene undergarment, a bra, a nursing bra, a bathing suit, an animal outfit, disposable tracking clothes, or baby/toddler pull-ups, etc.

An apparatus for producing small quantities of customized products on a mass production line is also disclosed.

In one embodiment, the apparatus comprises a manufacturing line having a main program driven manufacturing control processor to convert and apply prerecorded consumer information into production orders to be used on a versatile production line, and to enable a dedicated production process for an individual consumer.

The versatile and adaptable production line is a line of production specified to produce tailored on demand (custom made) disposable nonwoven articles, garments and undergarments using prerecorded consumer's information.

In one embodiment, the versatile and adaptable production line may comprise a material selector to enable quick change in material color and or type. The material selector may include one or more containers, each having a relevant material. The selector chooses which material to use at any given time, according to each product specification, as chosen by a consumer. In the case of a liquid or powder material, a relevant valve on the selector is opened to allow access to the chosen material. In another embodiment, an application head may be brought from a standby position to a working position.

In another embodiment the versatile manufacturing line may also comprise a fragrance application device, which may function in a similar manner as described above with respect to the material selector.

In yet another embodiment the versatile manufacturing line may further comprise a versatile product template changing mechanism. In yet another embodiment the versatile manufacturing line may further comprise automated mold changing mechanism. The product template changing mechanism and automated mold changing mechanism are tool changers. The correct tool or mold is lifted from a standby position to an engaged position to work as part of the production line. When another tool or mold is needed, the changing mechanism exchanges the tool or mold with another one.

In yet another embodiment the versatile manufacturing line may further comprise an automated pad feeding machine comprising real time changeable pad type and size. The automated pad feeding machine may function in a similar manner as described above with respect to the material selector and fragrance application device. The automated pad feeding device picks the selected pad from a dispenser, a roll, or a magazine, for example.

In yet another embodiment the versatile manufacturing line may further comprise a decoration application device to apply decorations to the disposable garment.

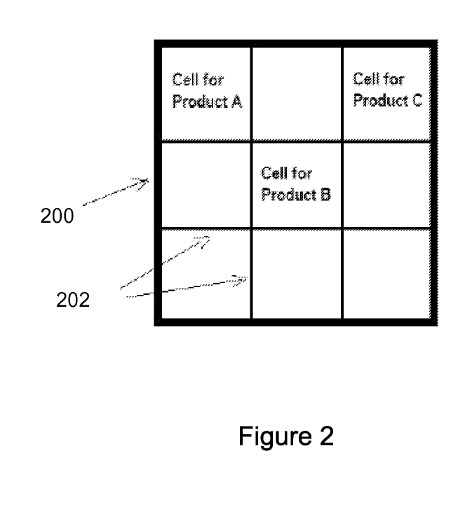

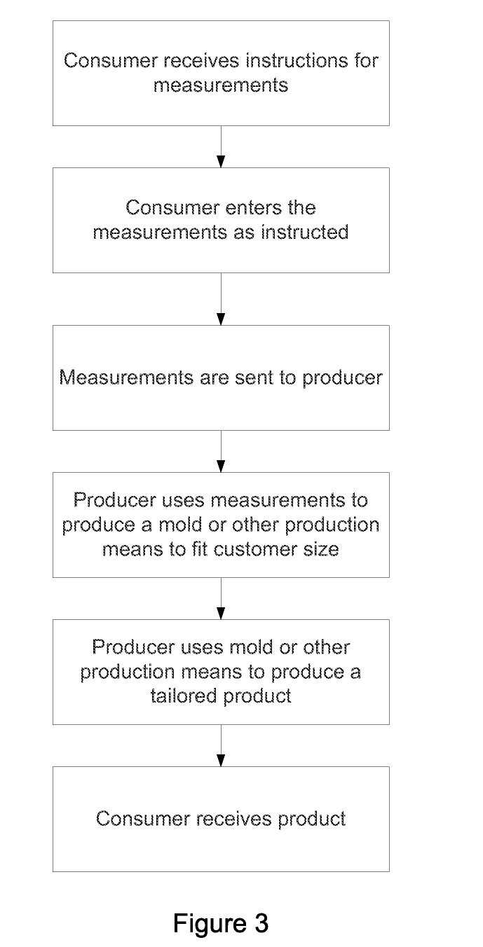

The individual products may be individually packed and displayed in a box 200, as depicted in FIG. 2. The box may be similar to a drawer, with dividing walls 202 to create smaller cell, thus allowing the consumer to easily choose from the variety of products in the box.

1. A method for producing and marketing tailored on demand disposable garments
and undergarments, wherein the method has at least one element driven from a personal demand of a consumer, or wherein the disposable garment is sold to the consumer with means to be used for customizing products appearance, and wherein the disposable garment is customized according to one or more parameters, the parameters comprising one or more of consumer body measurements, a 3D body scan, style, color, design, decorations, perfumes, decor additions, the addition of a specific absorptive device, or combinations thereof.

2. The method of claim 1 and wherein the consumer is one or more of a baby, a toddler, a child, a teenager, an adult, or a pet.

3. The method according to claim 1 wherein said disposable garments comprise one or more of an incontinence undergarment, a feminine hygiene undergarment, a bra, a nursing bra, a bathing suit, an animal outfit, disposable tracking clothes, or pull-ups.

4. The method according to one of claims 1-3 wherein the consumer selects products from a catalog of different styles and designs to be sent to the consumer as a collection.

5. The method according to claim 4 wherein the catalog is an on-line catalog which is directly connected to planning pre-determined software, and which converts consumer on-line choices into a manufacturing plan.

6. The method according to claim 1-3 or 5 wherein the manufacturer integrates the consumer body measurements, or scanning data, with the chosen products' design. and styles to create the custom made products.

7. The method according to of claim 6 wherein the disposable garments are individually packed and displayed in a box having dividing walls to create smaller cells.

8. The method according to claim 1 wherein the parameters are compared to a pre-existing database to find a match within a defined tolerance, and wherein the match is used for production optimization of the disposable garments.

9. An apparatus for producing small quantities of customized products on a mass production line,
the apparatus comprising:
a main program driven manufacturing control processor to convert and apply a consumer's prerecorded information into production orders to be used on a versatile and adaptable production line; and
a versatile production line specified to produce tailored on demand disposable nonwoven garments and undergarments using the consumer's prerecorded information.

10. The apparatus according to claim 9 wherein the versatile production line comprises a material selector to enable quick change in material color and/or type.

11. The apparatus according to claim 9 wherein the versatile production line comprises a versatile manufacturing template changing mechanism.

12. The apparatus according to claim 9 wherein the versatile production line comprises a fragrance application device.

13. The apparatus according to claim 9 wherein the versatile production line comprises an automated pad feeding machine including a real time changeable pad type and size.

14. The apparatus according to claim 9 wherein the versatile production line comprises a decoration application device.
